(19) United States
(12) Patent Application Publication
(10) Pub. No.: US 2004/0143746 A1
(43) Pub. Date: Jul. 22, 2004

(54) Software license compliance system and method

(76) Inventors: Jean-Alfred Ligeti, Whistler (CA); Paul Ligeti, Beaconsfield (CA); Gilles Surprenant, Ville St-Laurent (CA); Claude Brisson, Beaconsfield (CA)

Correspondence Address: BULL HOUSSER & TUPPER, P O BOX 11130 3000 ROYAL CENTER, 1055 WEST GEORGIA STREET, VANCOUVER, BC, V6E 3R3, CA

(21) Appl. No.: 10/345,263

(22) Filed: Jan. 16, 2003

(51) Int. Cl. H04L 9/00

(52) U.S. Cl. 713/185

(57) ABSTRACT

A software license compliance system and method limits multiple access to a software program. License compliance software is associated with the software program which selectively prevents access to that software program. Each time a user accesses the software program the license compliance software accesses a remotely located database by means of a computer network or other connection to obtain a current unique validation code unique to that specific copy of the software program. If the code received from the database matches a current unique validation code stored in association with the software license compliance software on the user's computer the license compliance software permits the user to access and use the software program. A new unique validation code is generated and stored in the remotely located database as well in association with the license compliance software which replaces the current unique validation code which no longer functions to provide user access to the software program.

### BACKGROUND OF THE INVENTION

1. Field of the Invention

This invention relates generally to a computer software license compliance system and method, and more specifically to methods and systems for controlling access to software programmes to prevent unauthorised multiple use of those programmes.

2. Description of the Related Art

Most software, including typical “off-the-shelf” software is not copy protected and, other than restrictions contained in the Software License Agreement, a purchaser of a computer software product may make multiple copies of that software which may be loaded on multiple computer systems and used independently by multiple users on those systems. It is common knowledge that computer piracy, that is unauthorized use of copies of computer programmes, is a serious concern to software owners. According to the 2002 annual global software piracy study conducted by the International Planning and Research Corporation, dollar losses in 2001 due to software piracy was estimated at over ten billion dollars globally.

In the past, systems and methods have been developed to restrict unauthorized multiple access to a computer programme by permitting a user to access a programme with a particular password or code entry and denying access to other users who do not enter that password or code entry. However, these types of systems do not prevent multiple unauthorised access to a particular software programme as users can use multiple copies of the software by inputting the password or code entry to gain access to the software. As well, software which is not copy protected does not typically include any controls which prevent the use of unauthorized copies of the software, whether by means of password control or otherwise.

U.S. Pat. No. 6,101,607 to Bachand et al is an example of a method, system and computer programme product for selectively restricting access to a programme function in a computer system. The patent describes a system and method which restricts selected users' access to selected programmes or portions of programmes. A user having special use privileges selects and sets the authorization of each user of the computer system to either grant or deny that user access to a programme function from an application programme executing or running on the computer system under the user's control. The user having special use privileges can grant or deny user authorizations to portions of a programme, as well as an entire programme as a whole.

U.S. Pat. No. 5,745,879 to Wyman describes a method and system for managing execution of licensed programmes wherein a licensed programme, upon start-up, makes a call to a license server to check on whether usage is permitted. The license server checks a database of licenses and, if the particular use requested by that user is permitted under the license, a grant is returned allowing access to the software by that user. A variety of license alternatives can be provided based on a licensing relationship between a user organisation and the software developers.

However, neither of the systems includes a method and system for preventing multiple use of unauthorized copies of the software programme.

In many cases, software developers who sell software products, particularly those which are sold “off the shelf”, desire to limit use of the software programme to only one individual who is authorized to use the software and to deny access and use of the computer software programme to all others, including users of unauthorized copies of that software programme. This restriction is usually commensurate in scope with the grant of license in the software license agreement for that software. This ensures that the authorized user will remain in compliance with those license terms. As a consequence, there is a need for a license compliance method and system which permits only one authorized user to use a particular software programme, or a portion of that software programme, at any time and which denies access and use of that software and all copies of that software programme to all others who may attempt to use the software, or copies of it.

### SUMMARY OF THE INVENTION

A method of limiting multiple access to a software program is provided which includes the steps of:

(a) associating license compliance software with a software program to be secured from multiple access, the license compliance software selectively preventing access to the software program or to a part of the software program when installed on a user's computer;

(b) upon a user wishing to access the software program, by means of the user's computer:

(i) accessing a remotely located database by means of a computer network or other connection to obtain a current unique validation code associated with that specific copy of the software program; and

(ii) comparing the current unique validation code obtained from the database to a unique validation code associated with the user's software program on the user's computer;

(c) if the current unique validation code obtained from the database corresponds to the current unique validation code associated with the user's software program:

(1) permitting the user to use the software program;

(2) generating a new unique validation code associated with the specific copy of the software program; and

(3) updating the database with the new unique validation code and providing the new unique validation code to the user's computer to be stored in associated with the user's software program, the new unique validation code replacing the current unique validation code, the replaced unique validation code no longer functioning to provide user access to the software program.

The method may further include that the database is associated with a computer system comprising server software which generates the new unique validation code, provides it for storage on the user's computer and updates the database.

The method may further include the following steps after step (a) above:

(a1) establishing a unique activation code, storing it on the secure server and providing it to an authorized user of the software program concurrent with the sale or licensing of the software to the authorized user;

(a2) when the authorized user first installs the software requesting input of the activation code; and

(a3) upon input of the activation code, comparing it to the activation code stored on the secure server and if they match advancing to step (b) above.

The method may also include the following steps after step (a3) above:

(a3.1) requesting user input of a password;

(a3.2) storing the password on the secure server;

(a3.3) each time a user re-installs the software program and upon access of the software program by a user, requesting input of the password and the unique activation code; and

(a3.4) upon input of the password and the unique activation code advancing to step (b) above.

The method may include, before step (b)(i) above, the step of permitting a user to use the software program or the part of the software program a pre-determined number of times before requiring the user to proceed to step (b)(i).

The method may further include, at step (a2) above, the step of permitting a user to use the software program or the part of the software program a pre-determined number of times before requiring the user to proceed to step (a3) above.

The method may further include that at step (c)(3) above the new unique validation code is stored on the user's computer as a part of the software program or license compliance software. The method may further include that at step (a1) above the unique activation code is provided to the user by means of email. The method may further include at step (c)(3) above the new unique validation code is provided to the user by means of a connection over a computer network or other connection.

The method may further include, after step (a3) above and at step (b)(i) above, the step of if there is no unique validation code in the remotely located database directing the user to step (a2) above.

The method may further include that each time a user accesses the remotely located database and before permitting the user to use the software program at step (c)(1) above, verifying that the server associated with the database is authorized to provide the current unique validation code to the user.

The method may further include that the step of verifying that the server associated with the database is authorized to provide the current unique validation code to the user is undertaken by the steps of:

(a) generating a unique authentication code by means of a computer algorithm at the secure server containing the remotely located database;

(b) transmitting the unique authentication code to the license compliance software on the user's computer;

(c) generating a unique authentication code by means of the same computer algorithm at the user's computer;

(d) by means of the license compliance software on the user's computer, comparing the unique authentication code received from the secure server to the unique authentication code generated by means of the computer algorithm at the user's computer;

(e) if the two authentication codes match, permitting the user to use the software program at step (c)(1) above.

In another aspect of the invention license compliance software for securing a software program from unauthorized use is provided which includes:

(a) means for controlling access to a software program to be secured;

(b) means for determining a unique code element and associating it with the software program;

(c) means for receiving a unique code element stored remotely from the user's computer on activation of the software program for use by the user;

(d) means for determining whether the unique code element stored remotely from the user's computer matches the unique code element associated with the software;

(e) means for permitting access to the software program by the user if the means for determining determines that the unique code element stored remotely from the user's computer matches the unique code element associated with the software;

(f) means for establishing a new unique code element, different from any previous unique code element attributed to the software program, to replace the code element associated with the software and stored remotely from the user's computer if the means for determining determines that the unique code element stored remotely from the user's computer matches the unique code element associated with the software; and

(g) means for associating the new unique code element with the software program and storing it remotely from the user's computer.

The unique code element stored remotely from the user's computer is accessible to the user's computer through a computer network or other connection.

The software may further include means for storing the unique code element remotely from the user's computer)said means for storing being accessible to the user's computer through a computer network or other connection. The software may further include means for encrypting communication between the means for storing and the user's computer to prevent unauthorised access to the unique code element.

The software may further include means for verifying that the means for storage is authorized to provide the unique code element to the user through the computer network or other connection. The means for verifying may include:

(a) means, associated with the means for storing, for generating a unique authentication code by means of a computer algorithm;

(b) means for transmitting the unique authentication code to the user's computer;

(c) means, associated with the user's computer, for generating a unique authentication code by means of the same computer algorithm;

(d) means for comparing the unique authentication code received from the means for generating associated with the means for storing with the unique authentication code generated by the means for generating associated with the user's computer;

(e) means for permitting the user to use the software if the two authentication codes match.

### DESCRIPTION OF THE DRAWINGS

A preferred embodiment or embodiments will now be described with reference to the accompanying drawings, wherein:

FIGS. 1(A, B and C) is a block diagram of the activation process of the software license compliance system of the present invention;

FIGS. 2(A, B and C) is a block diagram of the validation process of the software license compliance system of the present invention;

FIGS. 3(A and B) is a block diagram of the re-activation process of the software license compliance system of the present invention;

FIG. 4 is a block diagram of the de-activation process of the software license compliance system of the present invention;

FIG. 5 is a block diagram of the developer's operational process of the software license compliance system of the present invention.

### DETAILED DESCRIPTION

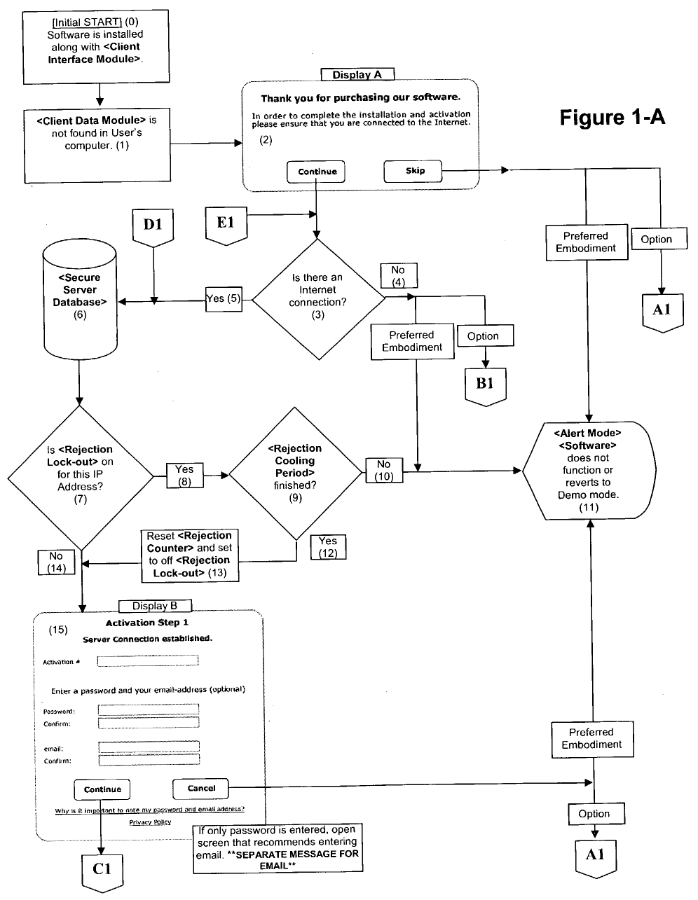

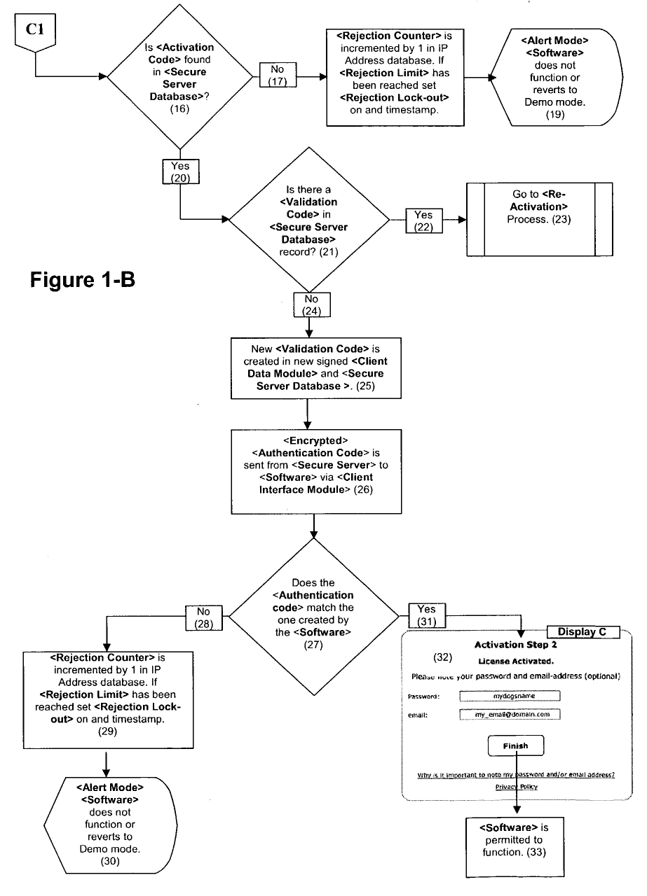

Referring to FIG. 1, a block diagram demonstrates the activation process of the software license compliance system of the present invention. In a preferred embodiment, software developers will incorporate applicant's software license compliance computer programme as a part of the software programme to be licensed to users. The software license compliance programme controls access to the software programme by requiring either an initial activation code upon installation of the software programme, or a validation code each time the software is accessed. The validation code changes each time a user accesses the software. Optionally, the software developer can provide a random or a fixed and pre-determined number of times the software programme can be accessed and used before the user must activate or validate the software programme.

There are two main license compliance features of the software system of the present invention:

1. A software license compliance activation system and method which controls initial installation, access and use of the software programme as well as de-installation and re-installation on another computer by authorized users who can input a unique activation code and user defined password.

2. A software license compliance validation system and method which provides ongoing control over the use of the software programme to ensure that only one user may use the software programme (or any copies of the programme originating from that software programme) at any time, and that users are limited in the ability to transfer authorizations from one user to another and to prevent use of the software programme by multiple users.

In each case, the license compliance system prevents use of the software programme by anyone other than an authorized user, that is the user who inputs an activation code, at the stage of initial installation and use. The software license compliance activation and validation system relies on a remote and secure server accessible on a computer network such as the Internet, or other connection, to control activation and ongoing use of the software programme.

Activation, De-Activation and Re-Activation

Activation

The flow chart of FIG. 1 describes the software license compliance method and system in a preferred embodiment for activating access to a software programme or a portion of a software programme following installation of the software programme on a user's computer.

Initially, a software developer who wishes to use the software license compliance system of the present invention will embed, within its software programme, a software programme (the “license compliance programme”), which implements the software license compliance system. This is the form in which the software programme is sold, or licensed, to the end user. The embedded license compliance software in the software programme selectively prevents access to the software programme or to a part of the software programme unless access is permitted based on user input of an activation code or if a validation is performed in the manner discussed below. The license compliance software includes a client interface module for communicating between the software and a secure server located remote of the user's computer and controlled by the software developer or the license compliance software vendor. The client interface module may be embedded within the software in a manner which renders it unavailable to a user. Alternatively, the client interface module may reside on the user's system as separate modules. Separating the client interface module from the license compliance software has the advantage for the developer of the license compliance software in maintaining its software more securely as a trade secret in that the source code for the license compliance software need not be provided to the developer of the software programme. However the more secure system of license compliance occurs where this module is actually embedded within the software programme.

The license compliance software also includes an encrypted client data module for entry and storage of encrypted data received from a secure server as more particularly described below. Because the client data module receives and stores data from the secure server it must be accessible to the secure server, through the client interface module, and as such is stored separately on the user's system. This enables the client interface module to read the data stored in the client data module and send it to the secure server and also to receive data from the secure server and store it in the client data module.

FIG. 1 describes the initial activation steps undertaken by the license compliance software upon initial installation and access to the software programme. A unique activation code which is unique to that particular computer software product purchased or licensed by that user is allocated to that copy of the software programme by the software developer. The activation code is stored in a database record on a secure server at a remote location from the software programme, the server being accessible to the license compliance software by means of a computer network or other connection such as a modem and telephone dial-up. In a preferred embodiment, the secure server, containing the database record with the unique activation code, may be accessible by the license compliance software through the Internet. Preferably, all copies of the software programme with the license compliance software embedded in it are identical when shipped by the developer and sold to all users. This provides a significant advantage in manufacturing and distributing the software programme as the software developer need not uniquely identify each copy of the software when manufactured. Each authorized copy of the software programme will be uniquely identified when the user's computer connects to the secure server operated by the developer of the license compliance software (or operated by the software developer) and the user provides a correct activation code whereupon the license compliance software records a validation code, all as described in more detail below.

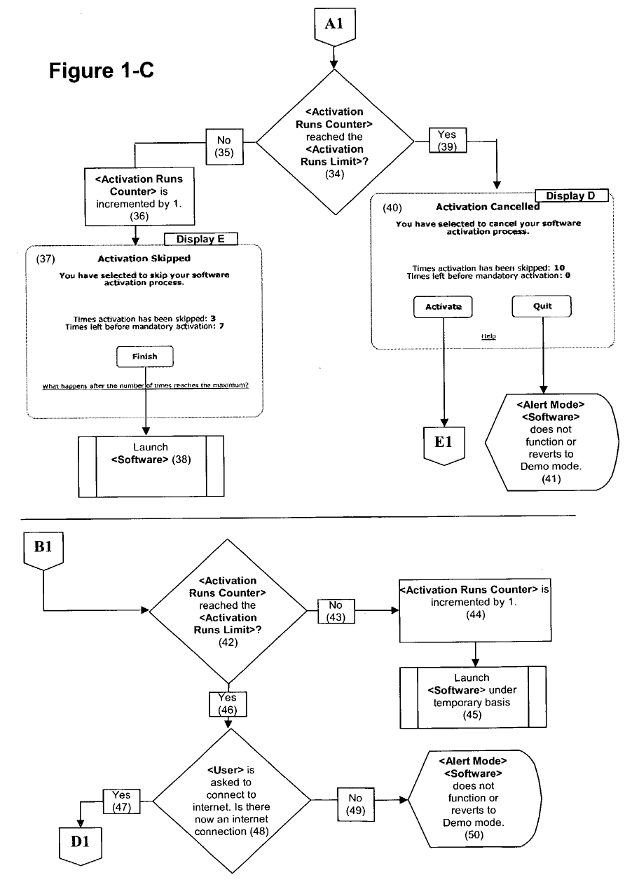

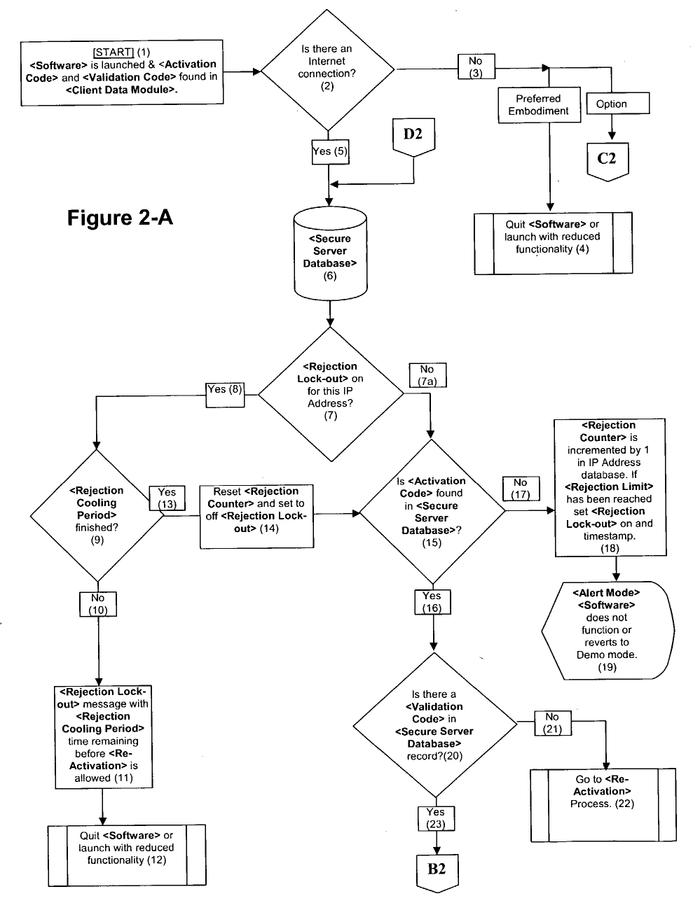

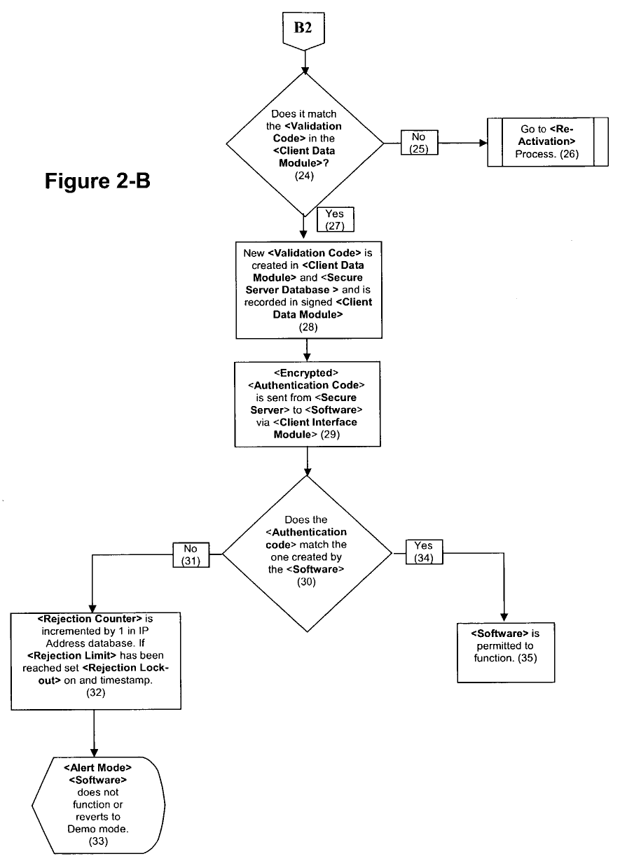

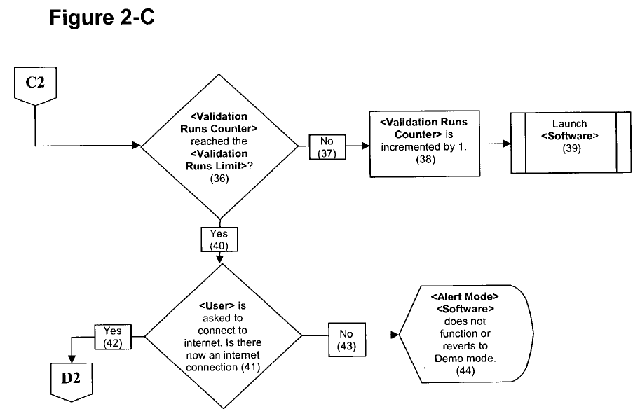

Referring to block 0 of FIG. 1-A, when a user initially installs the software programme, a search on the user's computer is undertaken to determine whether or not the client data module can be located. The client data module is a module located in the user's directory associated with the software programme which contains stored data which resulted from previous installation, activation and validation of the software programme in the past. If no client data module can be located (block 1 of FIG. 1-A), it means that the software has not been installed on that computer in the past or the computer hard drive has been formatted or otherwise modified to delete the client data module. On the other hand, if a client data module can be found the validation process, rather than the activation process, is implemented as provided below with respect to FIG. 2.

If no client data module can be located, the activation process, as described in FIG. 1 is implemented.

Block 2 of FIG. 1-A depicts a screen display sample (Display A) viewable by a user upon initial installation which, in the preferred embodiment, will not function unless a connection to the Internet (or any other computer network or connection) is available in order to complete the installation and activation process. The user has a choice of clicking on the “Skip” button, or the “Continue” button with the user's mouse or by entering appropriate key strokes to select the desired action. If the user selects the “Continue” button, the license compliance software will determine whether a computer network connection (eg. the Internet) or other connection to the secure server exists (block 3 of FIG. 1-A). If there is no computer network or other connection, the software programme may revert to partial functionality (such as a demonstration mode) or deny access to a user (block 11 of FIG. 1-A). If the user selects the “Skip” button, the software either does not function or reverts to partial functionality, such as a demonstration mode (block 11 of FIG. 1-A). Alternatively, the user may be provided with a random or fixed and pre-determined number of times he or she can access and use the software before the user must connect to the secure server and activate the software programme. This is described more fully below in Optional Embodiment for Activation Process.

In the event that a computer network or other connection to the secure server database is successful (block 5 of FIG. 1-A), a determination is made as to whether or not the rejection lock-out is on or off at block 7. A rejection counter stores the number of times an unsuccessful activation has occurred for this IP address and will not permit further activation if a pre-set maximum number of unsuccessful activations within a pre-determined time period is reached; referred to as “rejection lock-out” and depicted at block 7 of FIG. 1-A. The rejection counter is a field in the record database of the secure server which need not correspond to that copy of the software programme and which is tied to a particular IP address. The rejection lock-out is designed to ensure that only a limited number of attempts can be made by a particular IP address to input an activation number without resulting in a correct match with the activation number stored in the secure server database.

When rejection lockout is triggered, the user at that IP address will not be allowed to access the secure server during the rejection cooling period, a pre-configured amount of time set by the software developer.

If the rejection lock-out is on (block 8 of FIG. 1-A) and the rejection cooling period is not finished (block 10 of FIG. 1-A), the software either does not function or reverts to partial functionality, such as a demonstration mode (block 11 of FIG. 1-A). If the rejection lock-out is on and the cooling period is finished, the rejection counter is reset, the rejection lock-out is set to off and the user is allowed to continue the activation process (block 13 of FIG. 1-A)

At block 15 of FIG. 1-A (Display B), the user is requested to input a unique activation code which has previously been provided to the user. The activation code is provided to the user when the software is purchased, either by being included in the box or printed on other packaged material for software sold “off the shelf” or by way of e-mail or other notification if the user downloads his or her copy of the software from the Internet. The activation code is a unique code which acts as a key to a particular record on the secure server database which will, after activation of the software program, correspond to that particular copy of the software programme sold or licensed to the user. The user is further requested to enter a user defined password which is confirmed to ensure accurate entry. The user defined password is stored by the secure server in the secure server database record associated with that activation code and thereby corresponds to the user's specific copy of the software programme.

The user is further requested to input an e-mail address and to confirm that address at block 15 of FIG. 1-A (Display B). The e-mail entry step is optional and if the user does not enter this information, the activation process will still continue to complete initial activation of the software. The entry of a user defined password is required to allow the user to control or regain control of the software programme.

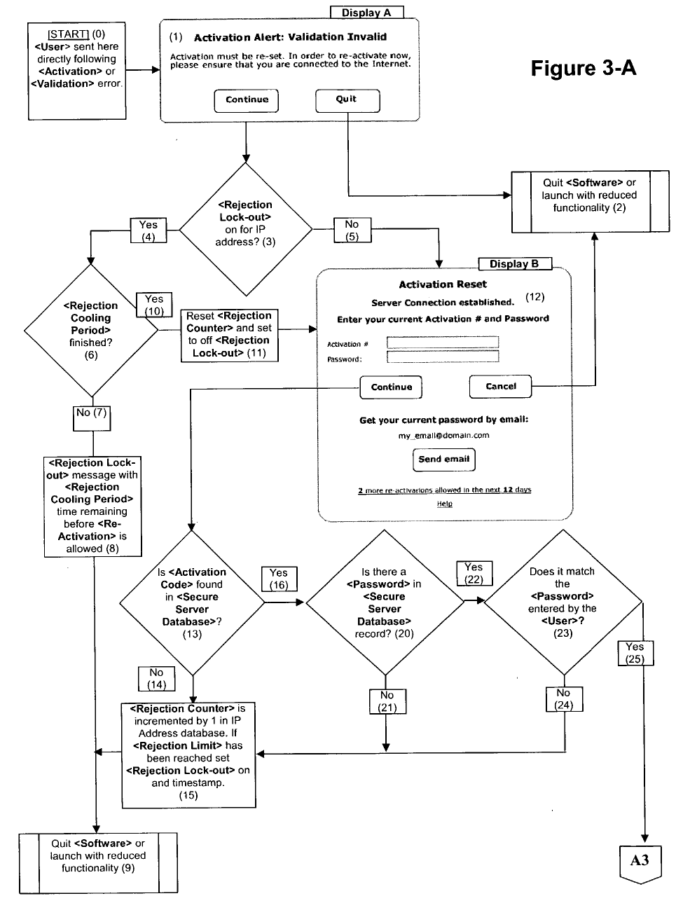

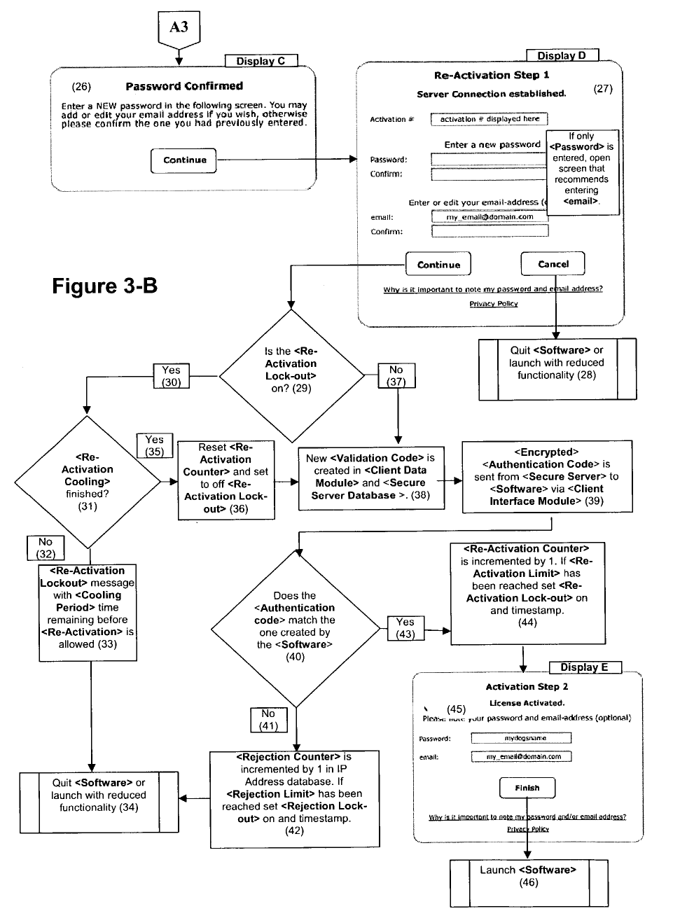

Entry of the user's e-mail address on activation of the software programme at block 15 of FIG. 1-A is also useful in the situation where user may have forgotten his password as on re-activation of the software programme at block 12 of FIG. 3-A, the password may be sent to the user on request at the e-mail address initially provided.

Optionally, at block 15, if the user does not enter an e-mail address, a separate warning may be displayed to the user which advises the user of the importance of entering an e-mail address at this stage.

The user then has a choice of selecting a “Continue” button or a “Cancel” button at block 15 of FIG. 1-A. If the user selects the “Cancel” button, in the preferred embodiment, the software either does not function or reverts to partial functionality, such as a demonstration mode (block 11 of FIG. 1-A). Alternatively, the user may be provided with a random or fixed and pre-determined number of times he or she can access and use the software before the user must connect to the secure server and activate the software programme. This is described more fully below in Optional Embodiment for Activation Process.

If the user selects the “Continue” button at block 15 of FIG. 1-A (Display B), a determination is made as to whether the activation code is found in the secure server database at block 16 of FIG. 1-B.

If it is not found, the rejection counter is incremented by one at block 18 and the software either does not function or reverts to partial functionality, such as a demonstration mode (block 19 of FIG. 1-B). If the rejection counter reaches the predetermined limit, rejection lock-out is set on (block 18 of FIG. 1-B). Once rejection lock-out is on, the user (i.e. at that IP address) can no longer enter further activation codes at block 15 (Display B) of FIG. 1-A. The user or users at a particular IP address are allowed a predetermined number of unsuccessful activation or re-activation attempts until the rejection limit is reached within a predetermined rejection period of time, following the first rejection time stamp or the last rejection lock-out time stamp. A rejection counter stored as a part of the secure server database record is incremented with each unsuccessful activation or re-activation occurrence during the pre-determined rejection period. If the rejection counter reaches the rejection limit within the rejection period, the user will not be allowed to access the software programme during the rejection cooling period, which is a pre-determined time period set by the developer residing as part of the secure server database record relating to that software programme and applying to all copies of the software programme.

Once there is a match between the activation code entered by the user and that found on the secure server database at block 16 of FIG. 1-B, a determination is made as to whether or not there is a validation code stored in the secure server database record corresponding to that activation code (block 21). If there is, it means that the software has been installed previously and is being reinstalled, for example when a user does not de-activate the software program from one computer and then installs it on another. The user is then directed to the re-activation process at block 23 of FIG. 1-B, as discussed more fully below with reference to FIG. 3.

If there is no validation code in the secure server database record at block 21, a new validation code is created by the secure server software and then transmitted by encrypted communication to the client interface module that stores it in a new, signed and encrypted client data module which is created and stored in the user's computer in an encrypted manner (block 25 of FIG. 1-B) and which remains inaccessible by the user. The client interface module looks after communication between the user's computer and the secure server. The client data module is signed by the license compliance software. The signature algorithm uses a combination of the activation code, identification numbers of selected hardware components of the user's computer and other data to create the signature used to sign the client data module. The signature is verified and changed every time the client data module is accessed to ensure there have been no attempts to modify the client data module to circumvent the license compliance software and system.

This system of validation codes ensures that there is no duplicate activation code being used by an unauthorized user, therefore preventing unauthorized copies and ensuring that only one copy of the programme is functioning at a time, or optionally as many as the software developer allows (configures) per activation code.

Once a new validation code is created at block 25 of FIG. 1-B, the server communicating with the software is authenticated by means of an authentication code. The encrypted authentication code is sent from the secure server to the software programme by the client interface module (block 26). Note that the authentication process is in effect undertaken each time there is a communication between the secure server and the user's software. The authentication code is designed to ensure that the user's computer is connected to the authorized secure server (i.e. the server operated by the developer of the license compliance software or the developer of the software) and validates the communication between that secure server and the user's computer. This prevents, for example, substitution of an unauthorized server to replace the authorized secure server; preventing an unauthorised server being set up to signal the software program that it has been successfully activated or validated, in a situation where that software program is an unauthorized copy or where incorrect activation and validation codes are provided from the user or the unauthorized copy of the software program to that unauthorized server in an attempt to circumvent the license compliance software and system. The process for generating the authentication code is further detailed below.

When the secure server sends the activation code and the related authentication code to the license compliance software embedded in the software programme, the software will run the authentication code algorithm and re-generate an internal authentication code, at block 27 of FIG. 1-B. The software will then test to match the license compliance software generated authentication code with the authentication code downloaded from the secure server, at block 27.

If there is no match, the rejection counter is incremented by one at block 29 of FIG. 1-B and the software either does not function or reverts to partial functionality, such as a demonstration mode (block 30 of FIG. 1-B). If the rejection counter reaches the predetermined limit, rejection lock-out is set on (block 29).

If there is a match, the client data module is updated and the password and e-mail entered by the user is confirmed (block 32 of FIG. 1-B, Display C). The user must select a “Finish” button at block 32 which completes the activation process and launches the software programme at block 33. The software programme has then been successfully activated and may be used by an authorized user subject to the validation process required each time the software programme is run, as discussed below.

If at any stage between when the computer network or other connection is established with the secure server and when the “Finish” button is selected at block 33 of FIG. 1-B, the connection is lost or activation fails for any other reason, the software is not launched, the rejection counter is increased by one and the license compliance software on the user's computer returns to the initial activation stage at block 1 of FIG. 1-A. Alternatively, the software is launched with reduced functionality such as in a demonstration mode, as provided at block 11 of FIG. 1-A.

Optional Embodiment of Activation

Because the user's computer may not always be accessible to the Internet, other computer network connection or other connection to enable activation or validation of the software programme by linking the license compliance software with the secure server, it is sometimes advantageous to permit a user to access the software programme a random or a fixed and predetermined number of times before requiring the user to connect to the computer network (e.g. the Internet) or other connection to activate or validate the software programme.

Referring to the Activation Process as depicted in FIG. 1, if the user either selects the “Skip” button at block 2 of FIG. 1-A, or the “Cancel” button at block 15 of FIG. 1-A, the license compliance software makes a determination of whether or not the activation runs counter is less than the activation runs limit at block 34 of FIG. 1-C. The activation runs limit is embedded in the software and the activation runs counter is stored in the client data module and keeps track of the number of times the user has accessed the software without activating it by linking the license compliance software with the secure server. If no client data module exists, it will be created by the license compliance software.

If the activation runs counter is less than the activation runs limit, the activation runs counter is incremented (block 36) and the screen depicted at block 37 of FIG. 1-C (Display E) is displayed to the user. The screen display at block 37 advises the user as to the number of times the activation process has been skipped and the remaining opportunities to use the software programme before mandatory activation will be required. The user selects the “Finish” button in order to launch the software (block 38). Optionally, the user can activate a link to a portion of the license compliance software that describes the effect of reaching the mandatory number of times the software can be launched without activation.

In the event that the activation runs counter has reached the activation runs limit at block 34 of FIG. 1-C, the screen at block 40 of FIG. 1-C (Display D) is displayed showing the number of times activation has been skipped (set at the maximum permitted, pre-determined by the developer of the software programme) and showing that zero activation times are left before mandatory activation is required. The user has a choice between selecting the “Activate” or the “Quit” buttons. If the user selects the “Quit” button the user exits the software or the software is launched with reduced functionality (for example in a demonstration mode), at block 41. If the user selects the “Activate” button at block 40 of FIG. 1-C, a determination is made as to whether a connection exists between the computer network or other connection and the secure server, at block 3 of FIG. 1-A and the procedure for activation is undertaken again as discussed above.

If there is no connection to the secure server (block 3 of FIG. 1-A) the license compliance software makes a determination of whether or not the activation runs counter is less than the activation runs limit at block 42 of FIG. 1-C. If the activation runs counter is less than-the activation runs limit, the activation runs counter is incremented (block 44 of FIG. 1-C) and the software is launched (block 45 of FIG. 1-C).

In the event that the activation runs counter has reached the activation runs limit at block 42, the user is asked to establish a connection between the computer network or other connection and the secure server (block 48 of FIG. 1-C). If no connection can be established, the software is launched with reduced functionality (for example in a demonstration mode), at block 50. If a connection is established (block 47), then the procedure for activation is undertaken again as discussed above.

Authentication Code Generation and Activation Code Generator

The Authentication process authenticates communication between the 3 main modules; the software programme; the license compliance software and the secure server. This ensures that none of these components may be hacked or replaced.

In a preferred embodiment as regards the authentication code generating process, the developer will create an algorithm (the “authentication code algorithm”) or formula and use it to generate authentication codes based on the activation code (and/or any arbitrary code that the developer chooses) to create a unique authentication code for each activation code. The developer will upload the authentication codes with the related activation codes to the secure server database. The developer will embed the same algorithm in the software programme. When the secure server sends the activation code and the related authentication code to the license compliance software embedded in the software programme, the software will run the algorithm and re-generate an internal authentication code (example: block 27 of FIG. 1-B). The software will then test to match the license compliance software generated authentication code with the authentication code downloaded from the secure server database (example: block 27 of FIG. 1-B).

Alternatively, in a simpler version, the authentication code can be a simple password located both in the software and on the secure server.

Alternatively also, the developer can either:

(a) Upload to the secure server the algorithm that will be used in the software programme and will be used by the secure server to generate an authentication code based on the activation code. Both codes are stored on the secure server. When the secure server sends the activation code and the related authentication code through the license compliance software to the software programme, the software programme will run the algorithm and re-generate an internal authentication code. The software programme will then test to match the software programme generated authentication code with the authentication code downloaded from the secure server database;

(b) download an algorithm created by the license compliance software developer and incorporate the algorithm in the software programme. The software developer will upload an authentication key to the secure server database for a particular software programme Product ID. The secure server will run the algorithm and generate an authentication code based on the activation code and the authentication key. Both codes are stored on the secure server. When the secure server sends the activation code and the related authentication code through the license compliance software to the software programme, the software programme will run the algorithm using the authentication key embedded in the software programme and the activation code and re-generate an internal authentication code. The software programme will then test to match the software programme generated authentication code with the authentication code downloaded from the secure server database.

(c) upload a unique authentication key for each software programme product identifier. The unique authentication key is a word, numbers or any alpha numeric code created by the developer with or without any relation to the software programme. In this case the authentication key serves as the authentication code. The authentication code will be the same for every activation code for that software programme product identifier. It will be matched with the same authentication code that the developer has incorporated in the main software programme.

Note that in methods 1, 2 and 3, the generation of the authentication code may be performed by an activation code generator.

The activation code generator can be used by the developer to generate activation codes as an alternative to the developer generating his own generator of activation codes. The activation code generator may be used offline at his premises, online on the secure server or in real-time at the time of purchase of the software programme by the user.

If used offline, the developer will upload the activation codes and authentication codes to the secure server.

If used online, the activation code generator will generate the new activation codes. It may also call the authentication code algorithm to generate the matching authentication code. It will store the code(s) in the secure server. If used in real-time, the activation and/or authentication codes can be generated “on the fly” and need not necessarily be stored in advance in the server database.

If used in real-time, for example, as soon as the user's credit card has been accepted, the sale transaction script will call the activation code generator script and generate a new activation code. It may also call the authentication code algorithm to generate the matching authentication code. Subsequently, in real time, the activation code generator will upload the new codes(s) to the secure server and only send the activation code to the sale transaction script so that it may email the activation code and other transaction details directly to the user as well as an optional copy to the developer.

To create a random activation code, the activation code generator could use a random seed based on Date, Time, Product ID, as well as an activation code seed provided by the developer or other variables. This will ensure no relation between different activation codes.

De-Activation

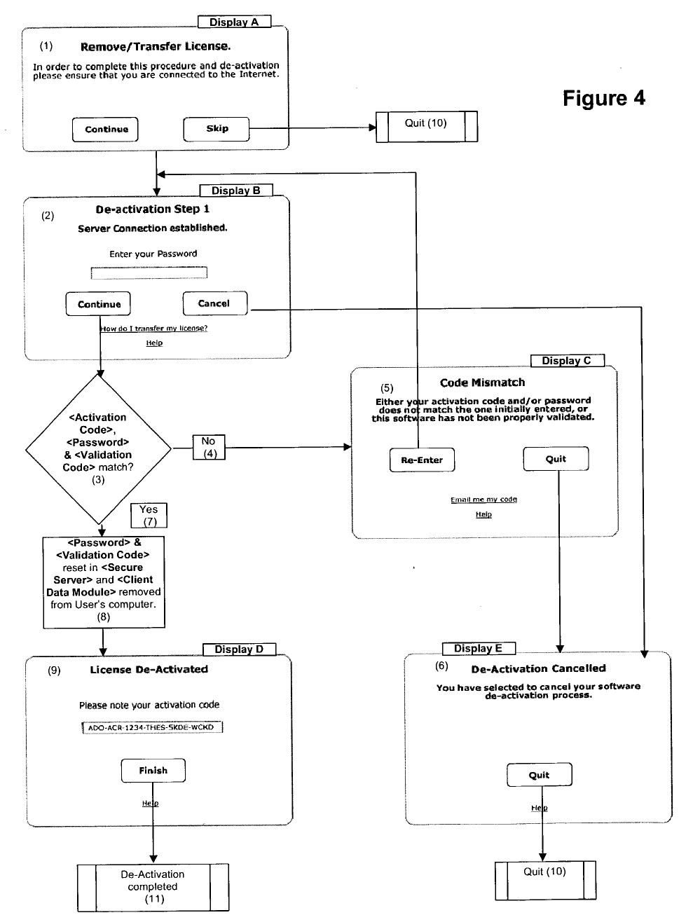

In the event that the user wishes to remove the software programme from the computer on which it resides, the software programme and the license compliance software associated therewith must be de-activated in order to permit activation of the software programme when it is installed on another computer. FIG. 4 is a flowchart of this process, including sample user screens. If the de-activation process is not performed upon removal of the software, upon re-installation of the software programme on that computer or installation of the software programme on another computer, the software will revert to an alert mode and then the user will have to re-activate the software programme in order to use it.

Upon the user initiating the process for removal of the software programme from the user's computer, the license compliance software associated with the software programme will cause the screen at block 1 of FIG. 4 (Display A) to be displayed to the user. If the user selects the “Skip” button, the software removal procedure quits at block 10 of FIG. 4. If the user selects the “Continue” button at block 1 and if a connection with the secure server has been established over the computer network or other connection, the screen at block 2 of FIG. 4 (Display B) is displayed to the user. The user is requested to enter the password which was entered at block 15 of FIG. 1-A. If the user selects the “Cancel” button at block 2 (Display B), the de-activation cancelled screen at block 5 (Display C) is displayed. The user may then select the “Quit” button in which case the software removal process quits at block 10 of FIG. 4 without removal of the software programme. Otherwise, the user may select the “Re-Enter” button to return to the password entry screen (block 2 of FIG. 4). Optionally, the user may click on a help link to be connected with a help programme to assist the user in de-activating software or to assist the user in obtaining the password through the e-mail address entered at block 15 of FIG. 1-A.

When the user enters a password and selects the “Continue” button, a determination is made at block 3 of FIG. 4 as to whether the user password matches the user password contained in the database record associated with the software programme stored on the secure server. As well, a determination is made as to whether the activation code and validation code stored in the license compliance software on the user's system (the client data module) matches the activation and validation codes stored in the secure server database record. The user password is entered in order to authenticate the user as being authorized to de-activate the software. This prevents an unauthorized user from de-activating the software and activating it on another computer.

If either the user password, the validation code or the activation code do not match that stored on the secure server database record, the screen at block 5 (Display C) is displayed. The user has the choice of either re-entering the password by selecting the “Re-enter” button in which case the user is returned to the screen at block 2 or the “Quit” button in which case the screen at block 6 of FIG. 4 (Display E) is displayed and the user quits the procedure by selecting the “Quit” button at block 6.

If the user password, activation code and validation code match the record on the secure server, the screen at block 9 of FIG. 4 (Display D) is displayed. Block 9 includes a display of the activation code for that copy of the software which must be noted by the user in order to re-activate the software programme on installation of the software programme on a computer system as described below. The user then selects the “Finish” button and the procedure is completed at block 11 with the successful de-activation of the software programme. On de-activation of the software programme, the client data module is removed from the user's system to be reinstalled on a system with the reinstallation of the software programme. The secure server database record is re-initialized upon de-activation and only the activation code remains. Optionally, the user password can remain in order to validate the same user on re-activation.

The software programme may now be uninstalled from the computer in a manner which will permit activation of the software programme at a later date.

Optionally, the screens displayed at blocks 2, 5, 6 and 9 can include a link to a help screen to assist the user in de-activating the software programme prior to uninstalling it from the user's computer. As well, optionally, block 2 can include a link to a page on the license compliance software which describes how the license to the software programme can be transferred to another user. As well, block 5 can include a link to permit an e-mail message to be sent to the secure server software, or the software programme developer, so that the password can be e-mailed to the e-mail address entered at step 15 of FIG. 1-A.

Re-Activation

If the software programme has not been previously removed from the computer system and de-activated in accordance with the de-activation procedure discussed above, the software programme must be re-activated so that it may be installed on a computer system. FIG. 3 is a flowchart of the method and system for re-activating the software programme upon installation of the software programme on a computer system so that it may be used.

Failing prior de-activation, upon installation of the computer programme on the computer system, an alert mode screen as depicted at block 1 of FIG. 3-A (Display A) is displayed to the user. The user may either select a “Continue” button, or a “Quit” button. If the “Quit” button is selected, the software either quits without the completion of the re-activation process, or the software is launched with reduced functionality, such as in a demonstration mode (block 2 of FIG. 3-A).

If the user selects the “Continue” button, a determination is made by the license compliance software at block 3 of FIG. 3-A as to whether or not the rejection lock-out is on. If rejection lock-out is on and the rejection cooling period is not finished, the user is provided with a message indicating that the system has locked out the user until the rejection cooling period has expired (block 8 of FIG. 3-A). No re-activation is allowed within that rejection cooling period. The software then quits without successful re-activation, or is allowed to run but with reduced functionality (block 9 of FIG. 3-A). If the rejection lock-out is on and the rejection cooling period is finished, the rejection counter is reset, the rejection lock-out is set to off and the user is allowed to continue the re-activation process (block 11 of FIG. 3-A)

If the rejection lock-out is not on and a successful connection is established between the computer network or other connection and the secure server, the screen at block 12 of FIG. 3-A (Display B) is displayed and the user is asked to input the activation code which was provided to the user upon purchase of the software as described above or provided to the user at block 9 of FIG. 4 and the user defined password which was input by the user upon activation of the software at block 15 of FIG. 1-A. If the user has forgotten his/her password, he/she can activate the “Send e-mail” button at block 12 of FIG. 3-A and the required password will be e-mailed to the e-mail address provided at block 15 of FIG. 1-A.

The user can then either select the “Continue” button, or the “Cancel” button at block 12 of FIG. 3-A. If the “Cancel” button is selected, installation of the software quits without successful re-activation or the software is allowed to run but operates with reduced functionality, all as provided in block 2 of FIG. 3-A.

If the user selects the “Continue” button at block 12 of FIG. 3-A, a determination is made as to whether the activation code entered by the user is found in the secure server database (block 13 of FIG. 3-A). If the activation code is found, then a determination is made whether there is a password in the secure server database record for this activation code (block 20 of FIG. 3-A). If there is, a determination is made as to whether the password provided by the user in block 12 matches the password in the secure server database record (block 23 of FIG. 3-A). If it matches, the screen of block 26 of FIG. 3-B (Display C) is displayed to the user to confirm that the password has been successfully matched and that the license compliance system recognizes that this is the authorized user of the software programme.

If the activation code entered by the user at block 12 of FIG. 3-A is not found in the secure server database (block 13), or if no password is found in the secure server database record for the activation code provided by the user (block 20), or if the password provided by the user at block 12 of FIG. 3-A does not match the password in the secure server database record (block 23), then the rejection counter is incremented by 1 at block 15 of FIG. 3-A. If the rejection counter exceeds the rejection limit then the rejection lock-out is set to on (block 15 of FIG. 3-A). Upon failure of the re-activation process, the software either quits or is allowed to run but operates with reduced functionality, all as provided at block 9 of FIG. 3-A.

On selecting the “Continue” button at block 26 of FIG. 3-B (Display C), the screen at block 27 of FIG. 3-B (Display D) is displayed. The activation code is displayed and the user is requested to enter a new password. The user can also optionally also change his or her e-mail address. Optionally, a link can be established at this screen to displays or web pages advising the user as to the importance of noting the password and e-mail address and also to the privacy policy of the software developer. As well, if the user does not enter an e-mail address, a screen displays a warning recommending that an e-mail address be provided.

At block 27 of FIG. 3-B, the user may select the “Cancel” button in which case the re-activation of the software is cancelled and the software either quits or is allowed to run with reduced functionality at block 28 of FIG. 3-B. If the user selects the “Continue” button at block 27, a determination is made as to whether or not the re-activation lock-out is on (block 29 of FIG. 3-B). The re-activation lock-out is designed to stop a group of unauthorized users from continually and successfully activating or re-activating the software by trading activation codes and passwords thereby permitting multiple users to access and use copies of the same software programme at different times.

If the re-activation lock-out is on and the re-activation cooling period is not finished (block 31 of FIG. 3-B), a message is provided to the user at block 33 of FIG. 3-B indicating the cooling period of time remaining before re-activation will be allowed. Software re-activation then quits at block 34. If the re-activation lock-out is on and the cooling period is finished, then the re-activation counter is reset and the re-activation lock-out is set to off at block 36 of FIG. 3-B, and the user is allowed to continue the re-activation process at block 38 of FIG. 3-B.

If the re-activation lock-out is off (block 37 of FIG. 3-B), a new validation code is created by the secure server software and then transmitted by encrypted communication to the client interface module that stores it in a new, signed and encrypted client data module which is created and stored in the user's computer in an encrypted manner (block 38 of FIG. 3-B) and which remains inaccessible by the user.

Once a new validation code is created at block 38 of FIG. 3-B, the communication between the server and the software is authenticated by means of an authentication code. The encrypted authentication code is sent from the secure server to the software programme by the client interface module (block 39 of FIG. 3-B).

When the secure server sends the activation code and the related authentication code to the license compliance software embedded in the software programme, the software will run the authentication code algorithm and re-generate an internal authentication code, at block 40 of FIG. 3-B. The license compliance software will then test to match the license compliance software generated authentication code with the authentication code downloaded from the secure server, at block 40.

If there is no match, the rejection counter is incremented by one at block 42 of FIG. 3-B and the software either does not function or reverts to partial functionality, such as a demonstration mode. If the rejection counter reaches the predetermined limit, rejection lock-out is set on (block 42).

If there is a match at block 40 of FIG. 3-B, the re-activation counter is incremented by 1 at block 44 of FIG. 3-B and the client data module is updated. If the re-activation limit has been reached then the re-activation lock-out is set to on (block 44). No further re-activations will be allowed within the re-activation cooling period which begins at the timestamp of this re-activation. The re-activation limit and the re-activation cooling period are set by the software developer and stored in the secure server.

The password and e-mail entered by the user is then confirmed (block 45 of FIG. 3-B, Display E). The user must select a “Finish” button at block 45 which completes the re-activation process and launches the software programme at block 46 of FIG. 3-B. The software programme has then been successfully re-activated and may be used by an authorized user subject to the validation process required each time the software programme is run, as discussed below.

If at any stage between when the computer network or other connection is established with the secure server and when the “Finish” button is selected at block 45 of FIG. 3-B, the server connection is lost or re-activation fails for any other reason, the software is not launched, the rejection counter is increased by one and the license compliance software on the user's computer returns to the initial re-activation stage at block 1 of FIG. 3-A. Alternatively, the software is launched with reduced functionality such as in a demonstration mode, as provided at block 9 of FIG. 3-A.

Validation

Validation of the software programme will now be discussed with reference to FIG. 2. The previous discussion related to activation of the software, either when first installed or properly de-activated in accordance with FIG. 4 when re-installed and re-activated. Once activated, or re-activated, the software programme must be validated each time it is used (or, if desired by the software programme developer, upon the validation runs counter reaching the validation runs limit, as discussed below).

Each time the software programme is launched, the license compliance software is run. The software checks to determine whether a client data module is found and correctly signed at block 1 of FIG. 2-A. This is to ensure that the client data module is still installed on the same computer as was the case when the software was previously run. The client data module is signed by the license compliance software. The signature algorithm uses a combination of the activation code, identification numbers of selected hardware components of the user's computer and other data to create the signature used to sign the client data module. The signature is verified and updated every time the client data module is accessed to ensure there have been no attempts to modify the client data module to circumvent the license compliance software and system.

The license compliance software then reads the activation code and validation code stored in the client data module at block 1 of FIG. 2-A. An attempt is made to connect the license compliance software to the secure server database by determining whether or not there is an Internet, computer network or other connection at block 2 of FIG. 2-A.

In the preferred embodiment, the license compliance software will determine whether an Internet connection, computer network connection or other connection to the secure server exists (block 2 of FIG. 2-A). If there is no Internet connection, computer network connection or other connection, the software programme may revert to partial functionality (such as a demonstration mode) or deny access to a user (block 4 of FIG. 2-A.)

Alternatively, the user may be provided with a random or fixed and pre-determined number of times he or she can access and use the software before the user must connect to the secure server and validate the software programme. This is described more fully below in Optional Embodiment for Validation.

If the user's computer is connected to the Internet, computer network or other connection (block 5 of FIG. 2-A) a connection is made between the license compliance software and the secure server database record that corresponds to the activation code.

If rejection lock-out is on (block 8 of FIG. 2-A) and the rejection cooling period is not finished (block 9 of FIG. 2-A) the user is provided with a message indicating that the system has locked out the user until the rejection cooling period has expired (block 11 of FIG. 2-A). No validation is allowed within that rejection cooling period. The software then quits without successful validation, or is allowed to run but with reduced functionality (block 12 of FIG. 2-A). If the rejection lock-out is on and the cooling period is finished, the rejection counter is reset, the rejection lock-out is set to off and the user is allowed to continue the validation process (block 14 of FIG. 2-A).

Rejection lock-out being on means that a user (that is, a particular IP address) has unsuccessfully attempted to activate or re-activate the software too many times and that a rejection cooling period is in effect before the software can be validated. The user is also prevented from using the software until that cooling-off period has expired and the software programme will not function, or functions with reduced functionality.

If the rejection lock-out is off (block 7a), a search is performed for the activation code in the secure server database record at block 15 of FIG. 2-A. If the activation code is not found, the rejection counter is incremented by one at block 18 of FIG. 2-A, rejection lock out is set on with a timestamp if the rejection limit has been reached, and the software reverts to its demonstration mode or does not function, as provided in block 19 of FIG. 2-A.

If the activation code is found in the secure server database at block 15, a determination is made by the secure server software at block 20 of whether a validation code is present in the secure server database record for that activation code. If not, the software goes to the re-activation process at block 22 of FIG. 2-A as discussed above with respect to FIG. 3. If there is a validation code in the database record (block 23) a determination is made at block 24 of FIG. 2-B of whether the validation code stored in the secure server database matches that stored in the license compliance software. If not, the software goes to the re-activation process at block 26 of FIG. 2-B and as discussed above with respect to FIG. 3.

If there is a match of the validation code in the secure server database record and the license compliance software (block 24 of FIG. 2-B), the secure server software creates a new validation code for that activation code and sends it to the license compliance software by means of encrypted communication where it is stored in the signed client data module which is stored in the user's computer in an encrypted manner (block 28 of FIG. 2-B) and which remains inaccessible by the user. The newly created validation code is also stored in the secure server database record to replace the previous validation code for that activation code.

Once a new validation code is created at block 28 of FIG. 2-B, the server communicating with the software is authenticated by means of an authentication code. The encrypted authentication code is sent from the secure server to the software programme by the client interface module (block 29). The authentication code is designed to ensure that the user's computer is connected to the authorized secure server (i.e. the server operated by the developer of the license compliance software or the developer of the software) and validates the communication between that secure server and the user's computer.

When the secure server sends the activation code and the related authentication code to the license compliance software embedded in the software programme, the software will run the authentication code algorithm and re-generate an internal authentication code, at block 30 of FIG. 2-B. The license compliance software will then test to match the license compliance software generated authentication code with the authentication code downloaded from the secure server, at block 30.

If there is no match, the rejection counter is incremented by one at block 32 of FIG. 2-B and the software either does not function or reverts to partial functionality, such as a demonstration mode (block 33). If the rejection counter reaches the predetermined limit, rejection lock-out is set on (block 32).

If there is a match, the software programme has then been successfully validated, the client data module is updated and the software programme may be used by the authorized user (block 35 of FIG. 2-B).

If at any stage between when the computer network or other connection is established with the secure server and when the authentication code is matched at block 30 of FIG. 2-B, the server connection is lost or validation fails for any other reason, the software is not launched, the rejection counter is increased by one and the license compliance software on the user's computer returns to the initial validation stage at block 1 of FIG. 2-A. Alternatively, the software is launched with reduced functionality such as in a demonstration mode, as provided at block 12 of FIG. 2-A.

Optional Embodiment of Validation

Because the user's computer may not always be accessible to the Internet or other computer network or connection to enable activation or validation of the software programme by linking the license compliance software with the secure server, it is sometimes advantageous to permit a user to access the software programme a random or a fixed and predetermined number of times before requiring the user to connect to the computer network (e.g. the Internet) or other connection to activate or validate the software programme. It should be noted that in the most secure embodiment of the present invention, users will not have the option of running the software programme without first connecting to the secure server and validating the software programme. Permitting users to run the software, even for a limited number of times, without this validation may provide unauthorized users with an opportunity to attempt to hack through the security features, particularly as regards the client data module and client interface module both of which are stored on the user's computer.

Referring to block 2 of FIG. 2-A, if there is no connection to the secure server, the license compliance software determines whether the validation runs counter has reached the validation runs limit at block 36 of FIG. 2-C. The validation runs limit is pre-set by the software developer as the maximum number of times the software can be run with full functionality until validation is required. The validation runs counter is a sub-routine of the license compliance software which keeps track of the number of times the software programme has been run without validation. If the validation runs counter has not reached the validation runs limit (block 36 of FIG. 2-C), the validation runs counter is incremented by 1 (block 38 of FIG. 2-C) and the software is permitted to function at block 39 of FIG. 2-C.

If the validation runs counter has reached the validation runs limit at block 36 of FIG. 2-C, the user is asked to connect to the Internet at block 41 of FIG. 2-C. If there is no Internet connection, computer network connection or other connection (block 43), the software is either not permitted to function, or reverts to limited functionality, such as a demonstration mode, at block 44 of FIG. 2-C.

If there is a computer network or other connection with the secure server (block 42 of FIG. 2-C) then the user is allowed to continue the validation process at block 6 of FIG. 2-A.

It should be noted that, other than the activation runs counter and the validation runs counter which are associated with the license compliance software stored in the client's computer, all other counters are stored in the remotely located secure server database including the rejection limit and the re-activation limit.

Developer Operation

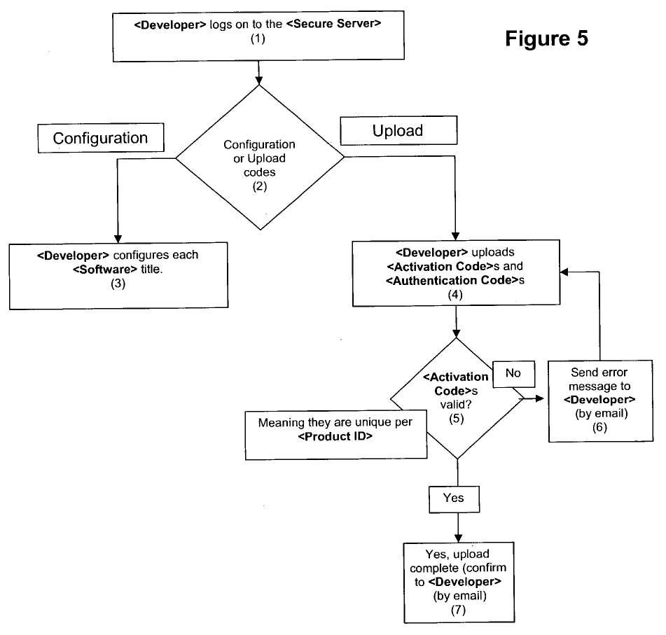

FIG. 5 depicts a flowchart describing a preferred embodiment for developers to upload activation codes and authentication codes to the secure server. The developer is permitted to access the secure server, for the purpose of providing activation codes and authentication codes to be used in securing use and access to its software products. The developer logs onto the secure server at block 1 of FIG. 5 using appropriate password codes. The developer then chooses to enter configuration information respecting its software product or to upload unique “upload codes” for a particular software product.

The developer uploads activation codes and authentication codes which it has previously generated as described above, at block 4 of FIG. 5. The server software then checks at block 5 of FIG. 5 to ensure that the activation codes are valid (that is, that they are unique for each product identification of that developer). If they are not valid an error message can be sent back to the developer so that the error can be corrected (block 6 of FIG. 5). If they are valid the upload is completed and is confirmed to the developer by e-mail at block 7 of FIG. 5.

Having thus described preferred embodiments of a computer software license compliance system and method, it will be apparent by those skilled in the art how certain advantages of the present invention have been achieved. It should also be appreciated that various modifications, adaptations, and alternative embodiments thereof may be made within the scope and spirit of the present invention. For example, a computer software license compliance system has been illustrated, but it should be apparent that the inventive concepts described above would be equally applicable to an endless array of applications including music compact discs and videos, Digital Video Disks (DVDs) and other products subject to a license agreement between the user of the product and the developer of the product. Moreover, the words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result. The described embodiments are to be considered illustrative rather than restrictive. The invention is further defined by the following claims.

1. A method of limiting multiple access to a software program comprising the steps of:
(a) associating license compliance software with a software program to be secured from multiple access, the license compliance software selectively preventing access to the software program or to a part of the software program when installed on a user's computer;
(b) upon a user wishing to access the software program, by means of the user's computer:
(i) accessing a remotely located database by means of a computer network or other connection to obtain a current unique validation code associated with that specific copy of the software program; and
(ii) comparing the current unique validation code obtained from the database to a unique validation code associated with the user's software program on the user's computer;
(c) if the current unique validation code obtained from the database corresponds to the current unique validation code associated with the user's software program:
(1) permitting the user to use the software program;
(2) generating a new unique validation code associated with the specific copy of the software program; and
(3) updating the database with the new unique validation code and providing the new unique validation code to the user's computer to be stored in associated with the user's software program, the new unique validation code replacing the current unique validation code, the replaced unique validation code no longer functioning to provide user access to the software program.

2. The method of claim 1 wherein the database is associated with a computer system comprising server software which generates the new unique validation code, provides it for storage on the user's computer and updates the database, all as provided at steps (c)(2) and (c)(3) of claim 1.

3. The method of claim 1 further comprising the following steps after step (a) of claim 1:
(a) establishing a unique activation code, storing it on the secure server and providing it to an authorized user of the software program concurrent with the sale or licensing of the software to the authorized user;
(b) when the authorized user first installs the software requesting input of the activation code; and
(c) upon input of the activation code, comparing it to the activation code stored on the secure server and if they match advancing to step (b) of claim 1.

4. The method of claim 3 further comprising the following steps after step (c) of claim 3:
(a) requesting user input of a password;
(b) storing the password on the secure server;
(c) each time a user re-installs the software program and upon access of the software program by a user, requesting input of the password and the unique activation code; and
(d) upon input of the password and the unique activation code advancing to step (b) of claim 1.

5. The method of claim 1 further comprising the following step before step (b)(i) of claim 1:
(a) permitting a user to use the software program or the part of the software program a pre-determined number of times before requiring the user to proceed to step (b)(i).

6. The method of claim 3 further comprising the following step at step (b) of claim 3:
(a) permitting a user to use the software program or the part of the software program a pre-determined number of times before requiring the user to proceed to step (c) of claim 3.

7. The method of claim 1 wherein at step (c)(3) of claim 1 the new unique validation code is stored on the user's computer as a part of the software program or license compliance software.

8. The method of claim 3 wherein at step (a) of claim 3 the unique activation code is provided to the user by means of email.

9. The method of claim 1 wherein at step (c)(3) of claim 1 the new unique validation code is provided to the user by means of a connection over a computer network or other connection.

10. The method of claim 3 wherein after step (c) of claim 3 further comprising the step of:
(a) at step (b)(i) of claim 1, if there is no unique validation code in the remotely located database directing the user to step (b) of claim 3.

11. The method of claim 1 wherein each time a user accesses the remotely located database and before permitting the user to use the software program at step (c)(1) of claim 1, verifying that the server associated with the database is authorized to provide the current unique validation code to the license compliance software on a user's computer.

12. The method of claim 11 wherein the step of verifying that the server associated with the database is authorized to provide the current unique validation code to the license compliance software on user's computer is undertaken comprising the steps of:
(a) generating a unique authentication code by means of a computer algorithm at the secure server containing the remotely located database;
(b) transmitting the unique authentication code to the license compliance software on the user's computer;
(c) generating a unique authentication code by means of the same computer algorithm at the user's computer;
(d) by means of the license compliance software on the user's computer, comparing the unique authentication code received from the secure server to the unique authentication code generated by means of the computer algorithm at the user's computer; and
(e) if the two authentication codes match, permitting the user to use the software program at step (c)(1) of claim 1.

13. License compliance software for securing a software program from unauthorized use, comprising:
(a) means for controlling access to a software program to be secured;
(b) means for determining a unique code element and associating it with the software program;
(c) means for receiving a unique code element stored remotely from the user's computer on activation of the software program for use by the user;
(d) means for determining whether the unique code element stored remotely from the user's computer matches the unique code element associated with the software;
(e) means for permitting access to the software program by the user if the means for determining determines that the unique code element stored remotely from the user's computer matches the unique code element associated with the software;
(f) means for establishing a new unique code element, different from any previous unique code element attributed to the software program, to replace the code element associated with the software and stored remotely from the user's computer if the means for determining determines that the unique code element stored remotely from the user's computer matches the unique code element associated with the software; and
(g) means for associating the new unique code element with the software program and storing it remotely from the user's computer.

14. The software as described in claim 13 wherein the unique code element stored remotely from the user's computer is accessible to the user's computer through a computer network or other connection.

15. The software as described in claim 14 further comprising means for storing the unique code element remotely from the user's computer said means for storing being accessible to the user's computer through a computer network or other connection.

16. The software as described in claim 15 further comprising means for encrypting communication between the means for storing and the user's computer to prevent unauthorised access to the unique code element.

17. The software as described in claim 15 further comprising means for verifying that the means for storage is authorized to provide the unique code element to the user through the computer network or other connection.

18. The software as described in claim 17 wherein the means for verifying comprises:
(a) means, associated with the means for storing, for generating a unique authentication code by means of a computer algorithm;
(b) means for transmitting the unique authentication code to the user's computer;
(c) means, associated with the user's computer, for generating a unique authentication code by means of the same computer algorithm;
(d) means for comparing the unique authentication code transmitted to the user's computer at step (b) of claim 18 with the unique authentication code generated at step (c) of claim 18; and
(e) means for permitting the user to use the software if the two authentication codes match.
